(19) United States
(12) Patent Application Publication
(10) Pub. No.: US 2011/0136090 A1
(43) Pub. Date: Jun. 9, 2011

(54) METHOD AND A DEVICE FOR PRACTICING DENTAL TREATMENTS

(75) Inventor: Saeid Kazemi, Hassleholm (SE)

(73) Assignee: DRSK Development AB, Hassleholm (SE)

(21) Appl. No.: 13/002,820

(22) PCT Filed: Jul. 7, 2009
(86) PCT No.: PCT/SE09/00359

§ 371 Date: Feb. 11, 2011

(30) Foreign Application Priority Data
Jul. 7, 2008 (SE) 0801628-9

(51) Int. Cl. G09B 23/30

(52) U.S. Cl. 434/263

(57) ABSTRACT

A method, system, device and an artificial tooth is disclosed for simulating both pain and anesthesia in a model of jaws. The tooth is equipped with sensors and connected to a data processing unit, memory unit and audiovisual display unit. The system is for teaching and practicing in the field of dentistry according to which removing artificial tooth or artificial bone substances by a dental drill, generates signals of pseudo pain with different intensities. Signals are fed to the data processing unit which simulates perception of the simulated pain and accordingly to said audio-visual display unit which simulates reaction to the different intensities of generated pseudo pain signals by playing different sounds which are stored in said memory unit. Furthermore, the system is able to simulate anesthesia by generating block signals as a result of applying different anesthetic techniques by means of a dental syringe connected to the system.

### FIELD OF THE INVENTION

The present invention relates to a method and a device for practicing dental treatments and can be used for simulating pain and anesthesia in a dental training model.

### DESCRIPTION OF THE RELATED ART

Teaching and training aids for the aim of training and simulation of dental students have been known from the state of the art. Document GB 1466907 entitled “Dental Patient Simulator” describes such a dental patient simulator comprising a phantom head, jaws and artificial teeth. Document U.S. Pat. No. 5,102,340 by Berling Hoff et al entitled “Dental Teaching and Practicing Apparatus” describes a teaching and training device comprising a cabinet with a hinged phantom head. Document JP5204300 by Yamaguchi entitled “Model Teeth for Dental Teaching” describes a model of a mandible comprising artificial teeth. These teeth consist of materials showing surface anatomy and mechanical properties similar to natural teeth, document EP 1912194 by Funakushi et al entitled “Multilayered Model Tooth for Dental Training” describes a multilayered artificial tooth to simulate different layers of a natural tooth.

In principle, the above mentioned training devices are suitable for simulating elementary dental operations. Those are commercially rather cheap and many manufacturers producing various types of these products in order to be used in different courses and treatment simulations in the dentistry field, but no simulation of feeling is provided.

More realistic simulators for the aim of training dental students are known from the state of the art. Document EP0822786 to Hayka et al entitled “Image Sound and Feeling Simulation System for Dentistry” describes such a simulation system comprising some sensors, a data processing unit, a handpiece and some more devices, the whole system imitates the sound and associated hand feeling, when drilling through tooth layers of different hardness.

Compared to the traditional models, this invention is rather more realistic. It helps the students to learn more effectively designing dental cavity preparations that remove healthy dentin no more than necessary by direct hearing the sound, feeling the associated hand feeling and additionally the simulated images on display unit.

As far as the dentist hand feeling is concerned, this simulator provides a reasonable simulation to imitate the hand feeling of a real tooth drilling.

As far as hearing the sound of drilling tooth on different layers is concerned, this simulator provides a realistic sound creation which is imitating the sound of tooth drilling in real practice.

As far as displaying the images simulated by the system is concerned, the above system provides an effective simulation.

However the above simulator suffers from the following limitations:

Firstly, using three different 3D sensors require a powerful data processing unit to interpret the incoming signals from sensors, resulting higher complexity of the system and more problems in support and maintenance.

Secondly, although using a processor on a computer machine is an easy way to handle signals coming from the sensors; it always imposes high expenses and dependency to a computer machine which of course acquires significant support. Power consumption is noticeable in long term.

Thirdly, required 3D sensors themselves, imposes high expenses to the whole system.

Fourthly, the simulator compared to the traditional simulators commercially is more than reasonably expensive even though the added functionalities are precious; it is not cost effective to the smaller dental schools in some cases to buy even one unit.

Fifthly, in spite of similarity of the hand and ear feeling to the real dentistry practice the trainee cannot get the feeling of working on a real tooth or patient.

Sixthly, 3D sensors may easily go out of calibration, which cause handling error.

JP2007328083 describes such a simulation system comprising teeth model, pressure sensors and a data processing unit. The whole system generates pseudo physical feeling of a patient while drilling teeth in a treatment session using pressure sensors.

This invention is also rather more realistic compared to the traditional models; it helps the students to feel closer to the clinic while they are practicing in pre-clinic.

As far as the patient perception of pressure on tooth as a pain stimulator is concerned, the above system can be effective in training.

However the above simulator suffers from the following limitations:

Firstly, similar to the previous invention using a processor on a computer machine is an easy way to handle signals coming from sensors; it always imposes high expenses and dependency to a computer machine which of course acquires significant support. Power consumption is noticeable in long term.

Secondly, compared to the traditional simulators commercially should not be cheap at least due to dependency to a computer machine and using piezo film sensors.

Thirdly, the simulator should suffer from a bias in differentiating the signals generated by pressure or drilling.

The latest is a major limitation since there is an obvious bias in interpreting the coming signals to the data processing unit.

JP2144053 discloses a system forming a closed circuit between the drill and the tooth. The tooth has two electrically conducting layers, simulating the dentin and pulp of a real tooth, respectively. The two layers are connected to the system in such a way that it is possible to detect in what layer the point of the drill is situated. However, the model according to JP2144053 does not allow simulation of anesthetic techniques. Also, the head of the drill is made of diamond, which is not conductive. Furthermore the artificial tooth is not stable in terms of electrical conductivity; the explained technique is not enough to manufacture a stable conductive material which can guarantee the conductivity in all parts of each layer.

WO 2008091434 describes an anesthesia model comprising an artificial model of upper and lower jaws containing sensing means. The sensing means are situated between the upper and lower jaws and are constituted by flexible switch membranes or a position sensor. A processing means then detects whether injections have been delivered in a suitable area. WO 2008091434 does however not disclose any output signal from the detector in the form of pain simulation, nor are there any means for simulating pain associated with drilling or injection.

Also the system according to WO 2008091434 is sensitive to pressure not touch which is not imitating the real situation.

The system according to WO 2008091434 also utilizes a computer with a network, which is costly.

JP5027675 describes a simulation system. This system is able to detect changes of potential when a drill touches two different layers in artificial tooth without a closed circuit. It shows detection of the position, the angle, and depth of a tip of the injector in nerve blocking training. The artificial teeth comprise two sensitive layers. Simulation of anesthetic techniques is also provided. However, the system according to JP5027675 uses electrostatic energy to generate signals, which is a major disadvantage since it makes the signals unpredictable and temporary. Once the sensor is touched, it is discharged and must then be charged again. There is no description of how this problem is solved. The anesthetic techniques are simulated in a quite unrealistic way.

The simulation of the function, however, is more complicated if pain simulation combined with other needed functionalities, for example, if it is possible to block the pseudo pain by applying local anesthetic technique to the model. For this purpose more realistic simulators are needed.

In addition to all clinically mentioned tips, there is a huge trend migrating from utilizing computer machines toward using effective simple embedded systems.

As it is understood from the above description it is very important to provide realistic simulators imitating teeth, jaws and nervous system as much as possible, in terms of functionality and anatomy both superficial and internal to have the gap between pre-clinic and clinic filled as much as possible and consequently training higher skilled pre-clinic students with less anxiety.

This can be achieved by using the following described system which is able to generate signals of pseudo pain, block pseudo pain and provide perception of different signals of pseudo pain and accordingly reacting.

### SUMMARY OF THE INVENTION

To overcome all above problems a new design of jaws and teeth is developed which follows the superficial anatomy and needed internal anatomy to imitate the generation of pain signals with different intensities, perception and reaction to the simulated pain signals according to natural dental layers. It provides the ability to block these pain signals by using four routine anesthetic methods, in the dental field. However, in a more general embodiment, any kind of anesthetic technique may be simulated in an analogous fashion. The injection simulation gives the trainee the chance of making mistake since the injection should be locally accurate so not always the injection is successful, meaning failure and success in injection like the real clinical practice.

Furthermore it can simulate the timing schema regarding to numbness similar to the real conditions, meaning that the time needed after injection to get the desired anesthesia which is 2-5 minutes and duration of numbness which is one or more hours.

However in a more general embodiment, the timing scheme may be adjustable within a predetermined range.

In an embodiment, the values within the predetermined range may be adjustable and arbitrary selected. In an embodiment, the time from injection to pseudo numbness, or the duration of pseudo numbness, may vary randomly within a suitably predetermined range.

In this design personal computer substituted by an embedded system to lower the cost of the system, charges of maintenance and consumed energy. An embedded system is able to process the data; this function makes the embedded system more effective than a simple detector while it has above mentioned advantages in comparison to using an external computer system, such as a desktop computer. Embedded system gives the ability to simulate pain and blocking function in a cost effective, efficient and functional fashion.

In an embodiment, the embedded system comprises a programmable processor, data memory, or audio-visual display.

An advantage with the present invention is the combined simulation of pain and anesthesia in a jaw model. In an embodiment, pseudo-numbness created by the anesthesia simulation, blocks pseudo-pain created by drilling.

Another advantage is that the anesthesia simulation is more realistic, due to the utilization of a timing schema. The system allows the timing of onset of anesthesia to vary, as well as the duration of the anesthetic effect.

Yet another advantage with the system is that it simulates numbness with different levels.

Also another advantage with the system is that it offers a more realistic way to simulate pain. Presence of pseudo-pain still can be displayed by the system even after contact with the dentin or pulp layers ceases. The time from ceased contact till ceasing of pseudo-pain may vary depending on which layer was touched.

Furthermore this system may simulate different dental operations on the jaw regarding pain and anesthesia. In one embodiment bone is acting as a sensor such as the model can be used for practicing dental implants.

### DESCRIPTION OF THE DRAWINGS

The invention described by way of example only, with reference to the accompanying drawings, where:

FIG. 1 A, B illustrates a longitudinal section of jaws and a tooth and connection of them with nervous system;

FIG. 2 A-C is presentation of drilling different layers of a real tooth;

FIG. 3 A-D illustrates 4 different routine anesthetic techniques and position of the dental syringe in the mouth;

FIG. 4 A, B is a schematic longitudinal section of the simulator system of pain and anesthesia in dental field;

FIG. 5 A, B is an example of using system in which the artificial enamel layer is drilled without generating any pseudo pain signal (NPPS);

FIG. 6 A, B is an example of using system in which the artificial dentin layer is drilled and low intensity pseudo pain signals (62) are generated;

FIG. 7 A, B is an example of using system in which the artificial pulp layer is drilled and high intensity pseudo pain signals (63) are generated;

FIG. 8 A-D illustrates applying 4 different routine anesthetic techniques and position of the dental syringe in the simulator system of pain and anesthesia in dental field;

FIG. 9 is an example of using system in which the syringe generates pseudo pain signals of lower intensity during injection;

FIG. 10 is an example of using system in which shows that the simulated injection is able to block the pseudo pain signals of the same region;

FIG. 11 is an example of using system in which shows that the simulated injection is not accurate and is not able to block pseudo pain of the higher intensity;

FIG. 12 is an example of using system in which shows that the simulated injection is accurate and is able to block pseudo pain of the higher intensity;

FIG. 13 is a schematic view of the second embodiment where the embedded system (46) measures the capacity of the sensor (56, 57) in an open circuit;

FIG. 14 is showing discharge time changes from dentin and pulp sensor in the second embodiment while a tool touches the sensors and the capacity changes.

FIG. 15 is a schematic view of the third embodiment where the embedded system (46) measures the electromagnetic resonance of the sensor (56, 57) towards the signal generator in an open circuit;

FIG. 16 illustrates changes of the input to the embedded system (46) in the second embodiment while a tool touches the sensors and the electromagnetic resonance changes, where F is Frequency and R is Relative Amplitude;

FIG. 17 illustrates a schematic longitudinal section of the simulator system of pain and anesthesia according to a second and third embodiment; and

FIG. 18, illustrate a multilayered sensor.

### DETAILED DESCRIPTION OF THE PREFERRED EMBODIMENT

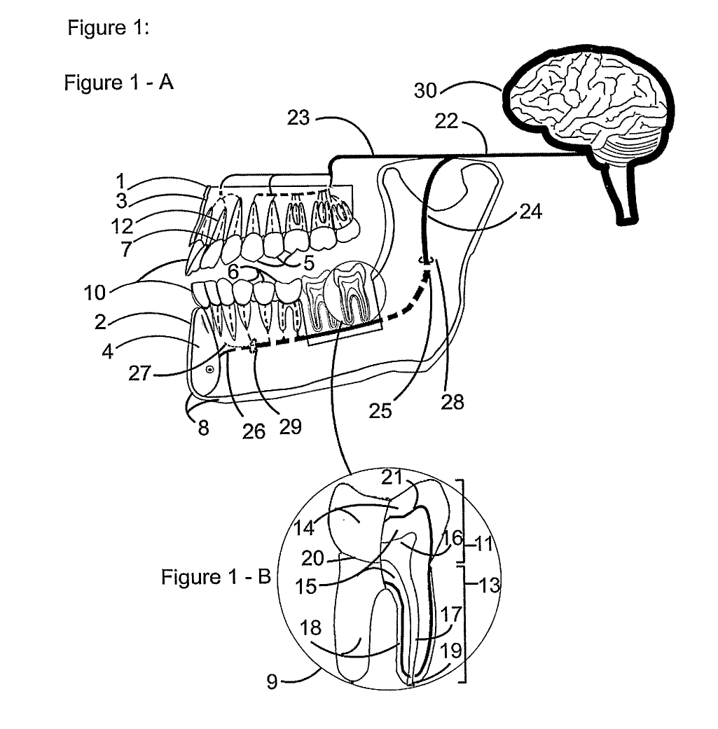

The structure of real jaws is shown in FIG. 1. Jaw is either of the two opposite structures forming the entrance of the mouth. The upper jaw (1) is called maxilla and the teeth located in this jaw are called maxillary teeth (5). The lower jaw (2) is called mandible and the teeth located in this jaw are called mandibular teeth (6).

Humans are heterodonts, meaning they have got teeth of different sizes and shapes. A tooth is divided into two parts: the crown (1O)(11) and the root(s) (12)(13). An individual normal tooth consists of an exposed crown (10) clinically visible above the gum line (7). A root (12) is clinically buried in the soft tissue (8) and the bone. In another categorization, anatomically a tooth is again divided into crown and root(s), the landmark defining the border line between crown and root(s) in this categorization is the cementoenamel junction (20) rather than the gum line.

Cementoenamel junction (20) is an anatomical landmark on a tooth where the enamel (14), which covers the crown (11) and the cementum (18) which covers the root(s) (13), joins.

A normal tooth is made of four distinct types of tissue: Enamel (14), Dentin (15), Pulp (16) and Cementum (18).

Enamel (14) is the outer layer of the tooth which covers the anatomic crown of the tooth. Mature enamel does not contain any living cell.

Dentin (15) is an intermediate layer in the anatomic crown; it is located directly beneath the enamel (14) and surrounds pulp (16). Dentin in anatomic root (13) is located directly beneath the cementum (18) and it surrounds the root canals (17). It contains tiny tubules throughout its structure which radiate outward from the pulp (16) toward the enamel (14) or cementum (18).

Dentinoenamel junction (21) is a surface located inside the crown and is the boundary between the enamel and the underlying dentin, where the enamel and the dentin of the crown of a tooth are joined. There are special cells known in the art as Odontoblasts (not shown), residing in dentinoenamel junction. These cells in one hand are connected to the nerve endings inside the pulp; on the other hand they have tiny projections which are going throw the tubules of the dentin. These projections are sensitive to some stimuli such as touch which can be transferred to the nerve through odontoblasts and generate the pain signal.

Cementum (18) is the outer thin layer of the anatomic root which surrounds the dentin.

Pulp (16) is a living tissue and highly sensitive to different stimuli. It is located in the central part of the tooth; pulp (16) is located in pulp cavity and contains nerves which may transmit pain signals toward the central nervous system (30). The extension of the pulp cavity within the root is called the root canal (17). Nerves reach the pulp cavity through the root canal (17) through an opening (19) in the cementum.

The nerves which are responsible to transmit pain signals from the maxillary teeth to the central nervous system are branches of maxillary nerve (23) which is a division of a cranial nerve called trigeminal nerve (22).

The nerves which are responsible to transmit pain signals from the mandibular teeth to the central nervous system are branches of mandibular nerve (24) which is another division of trigeminal nerve (22). One of The mandibular nerve's branches which enter to a canal in the mandible bone is called inferior alveolar nerve (25); it enters at the mandibular foramen (28) and runs forward in the canal, supplying the mandibular teeth. At the mental foramen (29) the nerve divides into two terminal branches: incisive (26) and mental (27) nerves. The incisive nerve runs forward in the mandible bone and supplies the anterior teeth. The mental nerve exits from the mandible bone at mental foramen (29).

Pain is an unpleasant feeling most often as a result of injury. Pain signals travel along pathways through the nerve endings to the central nervous system. In a tooth, pain travels into the central nervous system through the maxillary (23) and mandibular (24) nerves.

There are different occasions when a tooth might be drilled; the most common is removing tooth decay which is caused by certain types of acid-producing babteria resulting in progressive destruction starting from the surface of the enamel layer and undergoing gradually toward the dentin layer and afterwards toward the pulp. Traditionally tooth decay is removed by drilling and consequently filling the cavity with the suitable dental material.

Not only in removing tooth decay but in many dental treatments such as Crown, Bridge, Cosmetics and Root Canal Therapy, tooth drilling is inevitable.

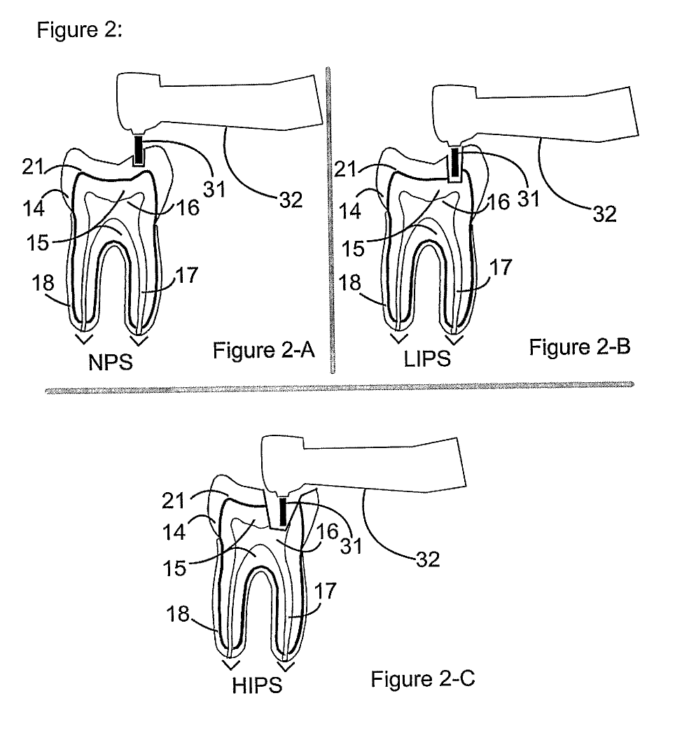

Now referring to FIG. 2, enamel (14) is not sensitive to pain stimuli, but both dentin (15) and pulp (16) are ‘live’ substances and are sensitive tissues and they play important roles in reception and transmission of pain signals. Cementum (18) is not a sensitive tissue to pain stimuli itself, but in some parts permeable which in some cases can stimulate the underlying dentin. The intensity of pain differs according to stimulation of the different layers.

A dental drill (31) which is installed in a high-speed handpiece (32) is a small drill used in dentistry to remove dental tissues. Drilling the normal dentin (15) or pulp (16) produces pain signals of different intensities (NPS: No Pain Signal, LIPS: Low Intensity Pain Signal, and HIPS: High Intensity Pain Signal) according to the layer of the tooth which is being drilled; these pain signals are normally both unpleasant and intolerable.

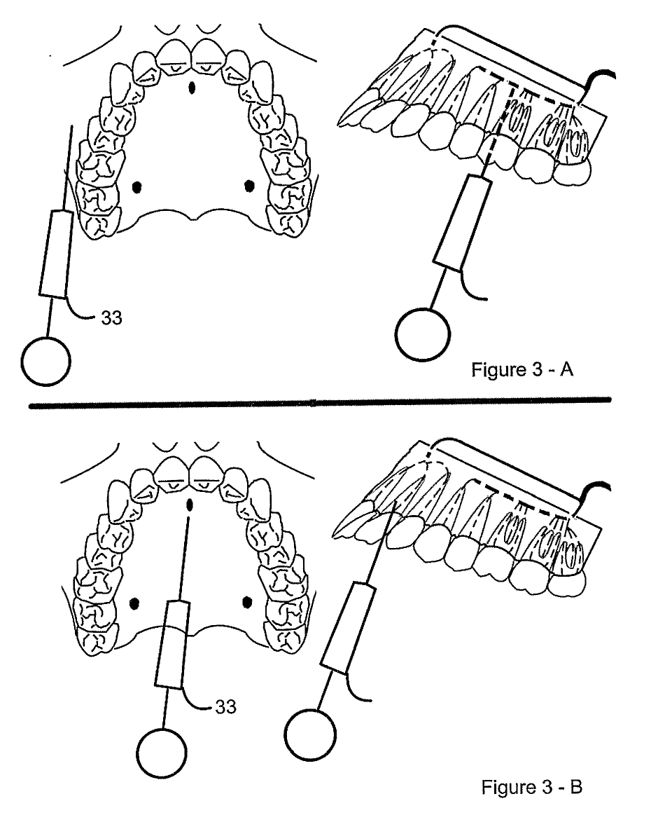

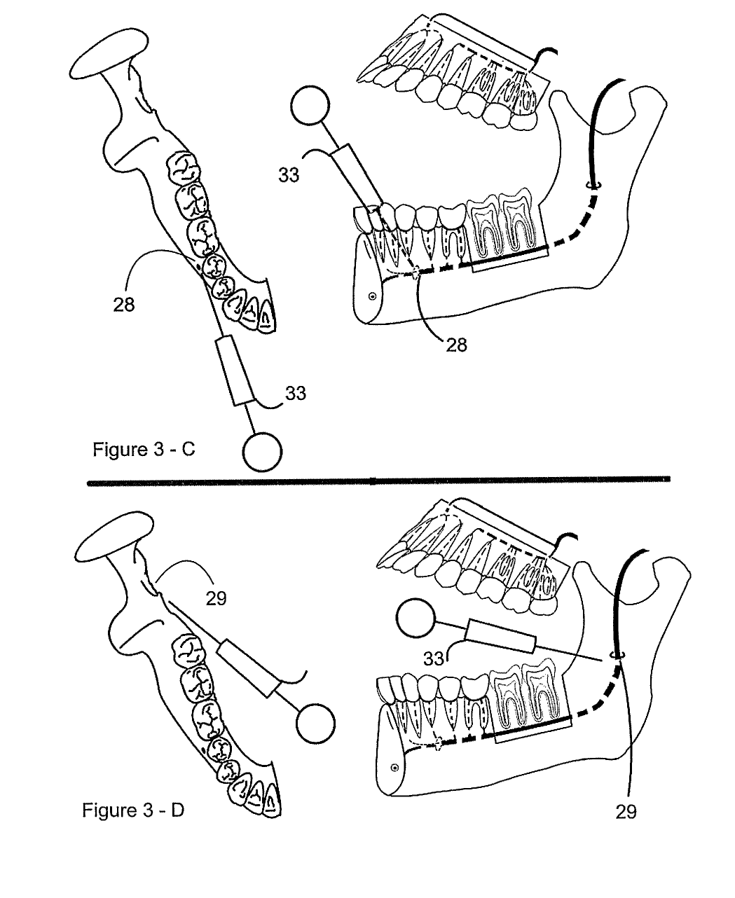

Now referring to FIG. 3, in some dental procedures when dentin or pulp is thought to be exposed, the dentist will desensitize a part of the jaw by injecting anesthetic agents into soft tissue. This procedure, called local anesthesia, will desensitize the area near the injection.

Two kinds of local anesthesia are possible, depending on where the dentist inserts the syringe. An infiltration (FIG. 3-A) injection desensitizes a small area, most often some teeth. A block injection (FIGS. 3-B, C, D) desensitizes an entire region of mouth, such as one side of the lower jaw (FIG. 3-D). In both cases, the numbness is short term and will last for one or more hours.

There are different techniques to accomplish these two local anesthesia techniques in the oral cavity. Some of the most common which are routinely used by practitioners are:
(i) Infiltration (FIG. 3-A) is the most basic dental anesthetic technique and one of the easiest to master. It can be applied to any maxillary tooth. Local infiltration injection is not the optimal technique for anesthetizing more than two or three adjacent teeth. This injection is a poor option for mandibular teeth because of the density of the bone overlying the teeth in mandible.
(ii) Nasopalatine nerve block (FIG. 3-B) is an anesthetic technique which desensitizes maxillary teeth from canine to canine.
(iii) Mental nerve block (FIG. 3-C) is an anesthetic technique which desensitizes the mandibular premolars, canine, and incisors on side blocked,
(iv) Inferior alveolar nerve block (FIG. 3-D) is probably the most widely used anesthetic technique in dentistry. It desensitizes all mandibular teeth to the midline on the side where the injection applied.

These techniques are examples only. Any kind of anesthetic technique may be simulated, such as greater palatine nerve block, lingual nerve block, buccal nerve block, infra orbital block, gow-gates technique.

Anesthetic techniques desensitize different parts of the mouth and they are not only used to desensitize the teeth.

The patient should experience numbness within 2 to 5 minutes of injection, and it lasts one or more hours. If the first attempt of injection fails to provide adequate pain relief, the procedure can safely be repeated for a limited number of attempts.

As mentioned above and referring to FIG. 2 enamel, dentin and pulp layers differ in their sensitivity to the pain stimulators. Using a dental handpiece to drill the crown three different substances (as classified according to their sensitivity to pain), are encountered. One type which is enamel and is not sensitive to drilling, a second type characterized by being sensitive is dentin, and the third type which is highly sensitive, is the pulp cavity. To block the pain signals from two sensitive layers to the central nervous system, local anesthetics are injected. The numbness depends on how accurate the technique is applied, thus for painless tooth drilling or any other operation on the jaw it is crucial to use the right technique in the correct position. Possibly an unsuccessful local anesthesia is not able to block the transmission of pain signals of higher intensity (such as pulp exposure) toward CNS, even though the pain signals of lower intensity (such as drilling the dentin layer) are being blocked by said unsuccessful injection. There are different pain signals in terms of intensity and different levels of numbness which may block some different pain intensities and not necessarily all.

Above descriptions suggest the dental students to learn related anatomy, physiology and right techniques. Dental students that take this approach will be able to perform dental operations without causing the patient severe pain and finally will be able to treat the tooth problem.

Dentistry as any other medical profession is based on wide variety of theory and practical trainings. Theory can be acquired from books, journals, slides, other publications and within lectures or seminars. The practical part is not as easy to be mastered as is the theory part, and it is divided into two stages which are pre-clinic and clinic.

In pre-clinic students learn the basic manual techniques using a variety of teaching aids such as artificial teeth, phantom jaws, phantom heads and simulators. These teaching aids try to simulate the real treatment steps and let the trainee to apply the methods and materials similar to which are used in clinic stage.

In contrast during the clinic period they will practice on real tooth and mouth.

There is always a big gap between pre-clinic and clinic, which is undesired, and tried to be filled as much as possible using the above teaching aids, resulting higher skilled students, before they leave pre-clinic to clinic.

The most commonly used apparatus in pre-clinic is traditional artificial jaw and teeth model, which are efficient to teach the superficial anatomy of the Jaws and teeth and how the teeth are embedded in the bone but they do not help the students to learn the functionality and in many cases internal anatomy of the real counterparts.

The present invention relates to a simulation system simulating both pain and anesthesia. Simulation of pain generates pseudo-pain. Simulation of anesthesia generates pseudo-numbness, which can block pseudo pain. This system is for the purpose of teaching and practicing in the field of dentistry.

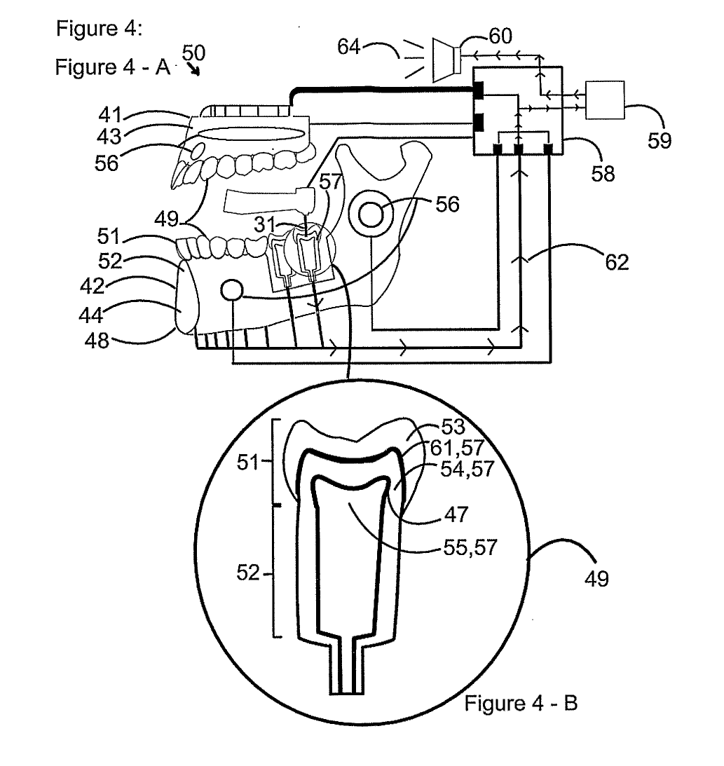

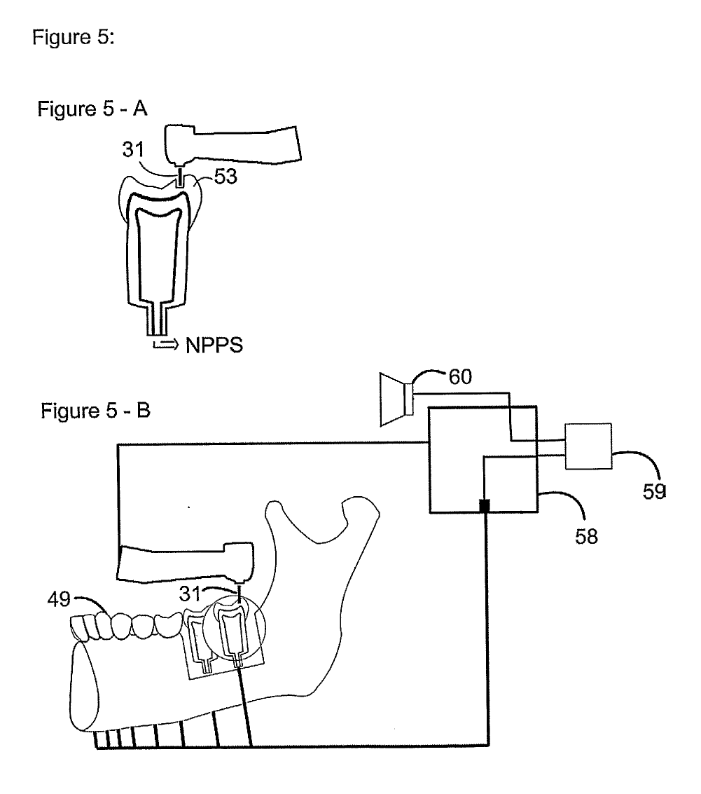

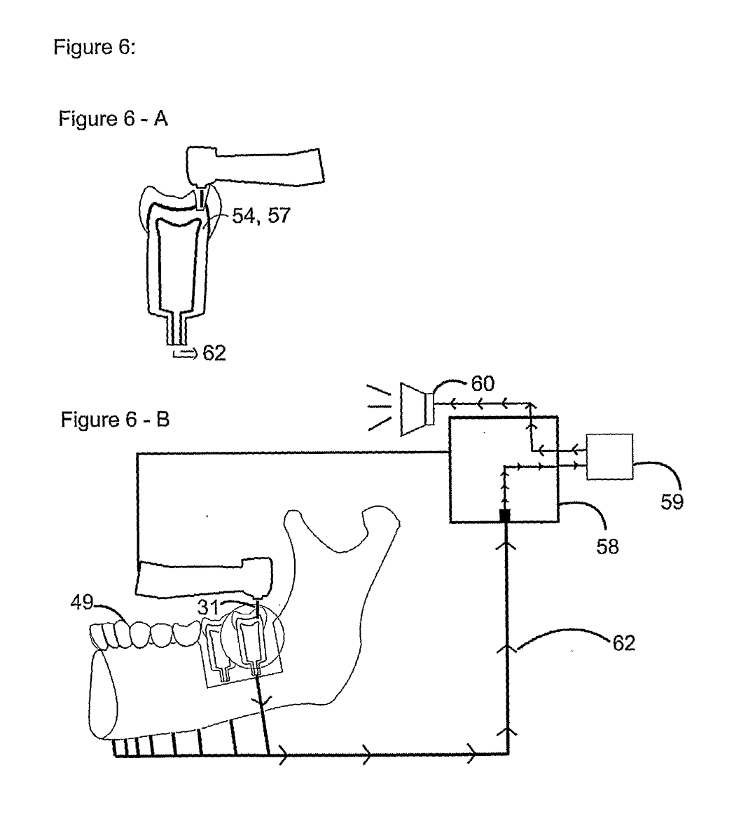

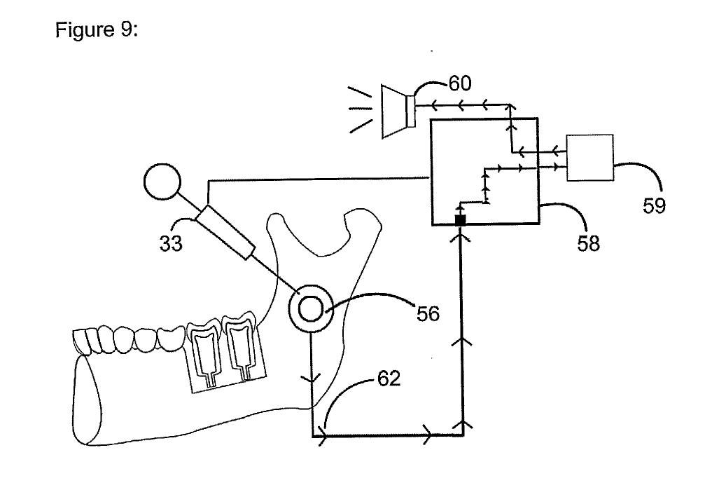

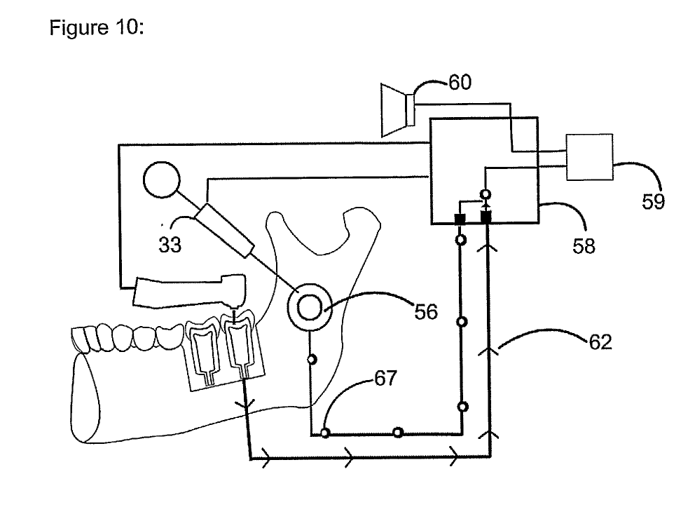

In particular, the invention provides a realistic simulation of tooth pain during drilling and a simulation of numbness as a result of applying dental anesthesia to block the simulated pain, by introducing a new jaws and teeth model which can (i) simulate generation of pain signals of a dental patient during both tooth drilling, shown in FIG. 6, 7, and injection, shown in FIG. 9 (ii) simulate generation of different tooth pain intensities while drilling different tooth layers, shown in FIG. 5, 6, 7 (iii) simulate perception of pain, shown in FIG. 4-A (iv) simulate reaction to the pain by outputting a human perceptible output, such as playing a sound, shown in FIG. 4-A (v) simulate perception and reaction to the different intensities of generated tooth pain signals by playing different sounds, shown in FIG. 5, 6, 7 (vi) simulate numbness in tooth/teeth as a result of applying dental anesthetic technique on the model, shown in FIG. 10, 12 (vii) simulate different levels of numbness as a result of applying different anesthetic techniques and accuracy of injection, shown in FIG. 10, 11, 12 (viii) simulate timing schema of numbness after injection (not shown). The human perceptible output also can be in the form of a visual indicator, such as a simple audio-visual display unit or in a simple embodiment light emitting means producing different levels of light intensity or different colors (not shown).

In an embodiment this simulator can however also simulate the painful or painless extraction of a tooth. Without pseudo numbness extraction of art artificial tooth generates pseudo pain and accordingly an audio-visual output. If the simulated injection in relative position to an artificial tooth would be successful, the generated pseudo pain while extracting the tooth is blocked and there is no audio-visual output from the system indicating existence of pseudo pain. On the other hand if the simulated injection would not be successful extraction is generating pseudo pain signal and audio-visual output like a screaming sound from the system.

Furthermore, in an embodiment simulator might be used as a model for practicing dental implants. In this treatment the bone is drilled instead of the tooth. Thus, the dental anesthesia should be applied to prevent pain. At the same time there are some critical anatomic positions in the bone that student should learn not to invade those positions while drilling. Examples of these positions: mandibular canal and mental foramen. In an embodiment the artificial bone of the jaws might act as a sensor, so drilling the bone may generate pseudo pain. Pseudo numbness may block this pseudo pain using a suitable anesthetic technique in accurate position, in accordance with the description below. Even with complete pseudo numbness the model generates an audio-visual output when the trainee invades the critical regions with the drill. Thus, the trainee learns the normal positions of these critical landmarks.

Specifically the present invention can be used by dental trainer and trainees to simplify and optimize the learning process of trainees in dental programs, furthermore helping them to improve their treatment skills.

The principles and operation of a simulation system according to the present invention may be better understood with reference to the drawings and accompanying descriptions.

The term touch sensor as used in this document and especially in claims refers to sensors capable of providing information regarding being sensed or touched by a dental tool such as a steel drill (31) or a syringe (33) needle.

Referring to the drawings, FIG. 4 illustrates the simulation system of the present invention referred in this document as system (50).

The system (50) comprising four units:
(i) Pain simulator unit (ii) Pain block simulator unit (iii) Perception simulator unit and
(iv) Reaction simulator unit.

Each of the above units comprises different components which are connected with connectors to each other

With referring to FIG. 4, Pain simulator unit consists of (i) touch sensors (57) inside the artificial teeth (49) (ii) touch sensors (56) in artificial jaws (41, 42) (iii) data processing unit (58).

Pain block simulator unit consists of (i) touch sensors (56) inside the artificial jaws (41, 42) (ii) data processing unit (58).

Perception simulator unit consists of (i) data processing unit (58) (ii) data memory (59).

Reaction simulator unit consists of (i) data processing unit (58) (ii) data memory (59) and (iii) audio-visual display unit (60).

A model of upper jaw (41) containing an artificial maxilla bone (43) enclosed by artificial gum substance (48) and equipped with removable artificial teeth (49) imitating a human upper jaw. Generally each part might be replaceable; it is not only artificial teeth (49) that may be replaceable. Also, the artificial gum substance (48) may be replacably arranged on the artificial bone. This applies for all embodiments of the herein.

A model of lower jaw (42) containing an artificial mandible bone (44) enclosed by artificial gum substance (48) and equipped with removable artificial teeth (49) imitating a human lower jaw.

Said artificial bones (43, 44), artificial gum substance (48) and artificial teeth (49) resemble natural counterparts in their morphology and hardness.

Said teeth and jaws model is supposed to simulate the needed functionality of the teeth and needed functionality of the nervous system inside the jaws to have a realistic simulation of both tooth pain during drilling and anesthesia, and pain during simulation of injection.

Each said artificial tooth (49) has one crown portion (51), which appears above the margin of the simulated gum, and a root portion (52) which is releasable and embedded in the said artificial bone (43, 44) of the said artificial jaws (41, 42).

Each said artificial tooth (49) is equipped with touch sensors (57) inside. Touch sensors are part of pain simulator unit; those are embedded in (i) simulated dentin layer (54) (ii) simulated pulp layer (55) which both have similar morphology and hardness as natural dentin and pulp layers. Said touch sensors are made of conductive material.

Each said artificial tooth (49) is equipped with touch sensors (57) inside. Touch sensors are part of pain simulator unit; those are embedded in (i) simulated dentin layer (54) (ii) simulated pulp layer (55) which both have similar morphology and hardness as natural dentin and pulp layers. Said touch sensors are made of conductive material.

In one embodiment the sensor is part of a closed circuit. When an electrically conductive material such as an electrically conductive handpiece (32) equipped with a steel drill (31) connected to the system touches the sensor, this closes an electrical circuit and a signal is sent. Depending on which sensor is touched, different signals may be sent.

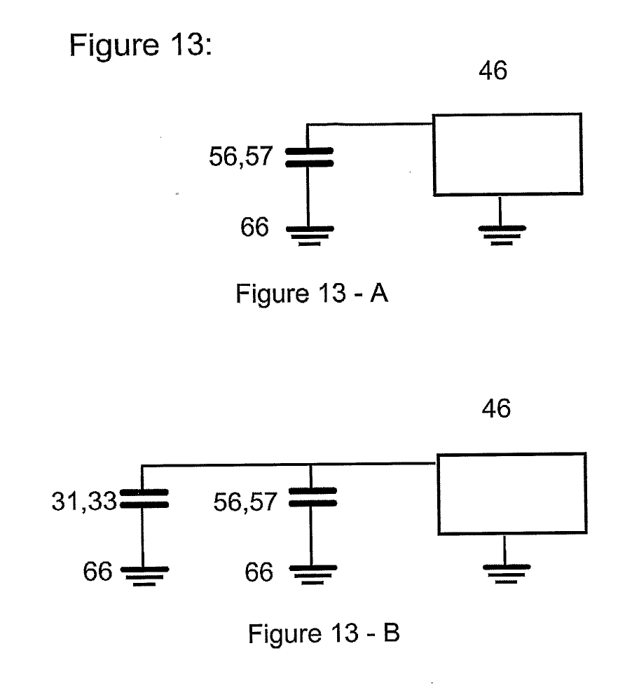

Referring to FIG. 13, in a second embodiment the sensor is part of a capacitor. The capacitor comprises the sensor (56, 57) and the ground (66) plane of the embedded system (46). The time and the potential during the periods that the capacitor is charged and discharged are continuously measured. When an electrically conductive handpiece (32) equipped with a steel drill (31) or a syringe (33) touches the sensor, capacity changes. The charging and discharging time is then affected. This change is detectable and measurable regarding which sensor is touched, Depending on which sensor is touched, different signals may be sent.

An advantage with second embodiment is that there is no need for a closed circuit. Furthermore, measurements may be more accurate and reliable. Also, the simulation is cost effective. And yet another advantage is that the trainee can use water sprayed to tooth while drilling.

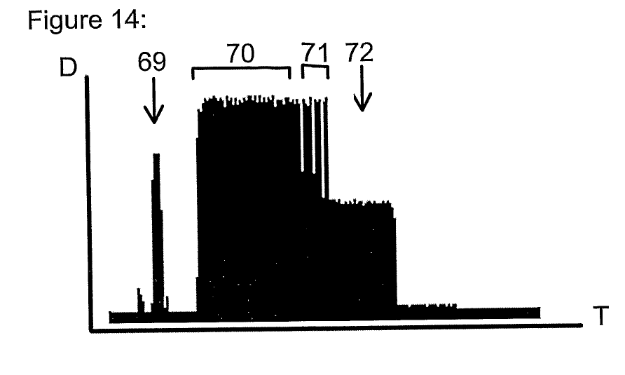

Referring to FIG. 14, charge time changes in dentin and pulp sensor when a conductive material touches or drill different layers in an artificial tooth. In the second embodiment while a tool touches the sensors the capacity changes. The changes are shown in this figure where dentin is touched (69), dentin is drilled (70), dentin is being drilled and pulp is touched (71), and pulp is drilled (72), where T is time and D is discharge time.

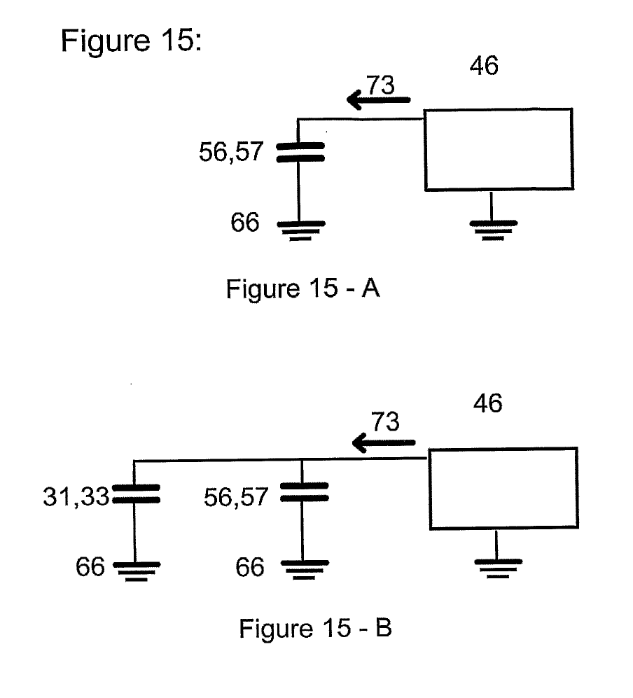

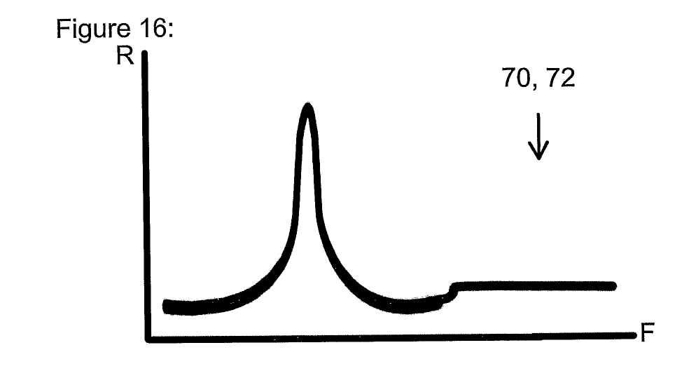

Referring to FIG. 15, in a third embodiment the sensor is a part of a electromagnetic resonance circuit. A high frequency sweep signal (73) is affected by the electromagnetic resonance in the sensor (56, 57) material. This is detectable by the embedded system (46). When an electrically conductive handpiece (32) equipped with a steel drill (31) or a syringe (33) touches the sensor, the electromagnetic resonance is affected. This change is detectable and measurable. The measurement can generate real time feedback by the reaction simulator unit to the user, regarding which sensor is touched. Depending on which sensor is touched, different signals may be sent.

An advantage with the third embodiment is <′> that there is no need for a closed circuit. Furthermore, measurements may be more accurate and reliable.

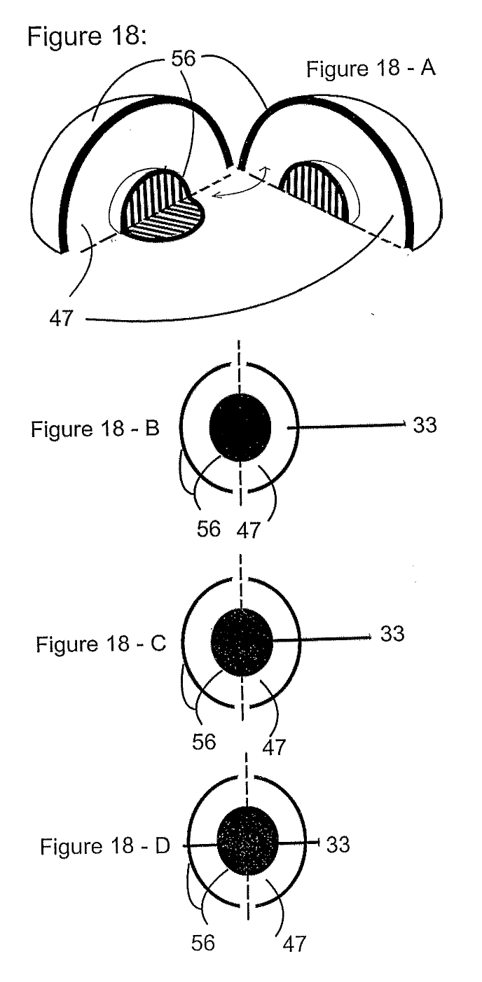

A first touch sensor (57) forms a simulated dentinoenamel junction (61) and simulated dentin layer (54); said touch sensor (57) comprises in one embodiment an electrically conductive layer. A second touch sensor (57) forms a simulated pulp layer (55) and comprises in one embodiment an electrically conductive layer. There is an insulating layer (47) between simulated dentin (54) and simulated pulp (55) layers. A third touch sensor (56) forms a simulated nerve and comprises in one embodiment an electrically conductive layer. In an embodiment, the third touch sensor (56) is a multilayered sensor according to FIG. 18. In this embodiment an electric circuit will be closed when the dental tool made of an electrically conductive material reaches electrical contact with the conductive layers forming the touch sensors. The data, processing unit (58) will respond to the closure of the electric circuit and as a result output the associated signal.

Each said artificial jaw is equipped with touch sensors (56) inside which are part of pain block simulator unit and pain simulator unit; those are embedded in special anatomic landmarks adopted from the natural counterpart to imitate pain block and pain signal generation during injection.

Said pain simulator unit is able to generate signals of pseudo pain (62, 63) while tip of the drill exposes and removes one of the sensitive layers of the artificial teeth (49), these layers are simulated dentin (54) and pulp layer (55).

Each said artificial jaw might act itself as a sensor, and then it can imitate pain signal generation during drilling the jaw (not shown).

The artificial tooth according to the embodiments herein may be exemplified by FIG. 4B. This artificial tooth may be manufactured by first molding a pulp (55). The material of the pulp (55) may suitably be selected from the group of polymers below, comprising an electrically conductive material according to below. Preferably, conductive silicone rubber, i.e. silicone rubber mixed with carbon or iron based material, is injected in the mould. An insulating layer is then applied onto the pulp (55). This insulating layer may be silicone, or any other material indicated below with regard to non-conductive materials. When the insulating material is Thermoplastic urethane (TPU) a good insulation is accomplished while simultaneously imitation of a real tooth is good. The pulp (55), now provided with an outer layer of an insulating material, is then arranged in another mould. This mould corresponds to the dentin part (54). The dentin part (54) may thus be manufactured by molding the dentin part onto the insulating layer. The material of the dentin part (54) may suitably be selected from the group of polymers below, comprising an electrically conductive material according to below. The pulp (55) and the dentin part (54) are the insulated from each other. Leads are connected to the pulp (55) and the dentin part (54). These leads may be connected to the data processing unit (58) or that may end up in electrical terminals that are connectable to terminals in the jaw, which in turn is connected to the data processing unit (58). Thus, the tooth may be connected to the data processing unit by inserting the tooth into a corresponding socket in the jaw. In this way the teeth in the jaw may be replaceable, once the teeth have been worn out or if they for other reasons cease to operate satisfactory. Then, the pulp (55), insulating layer and dentin part (54) is arranged in yet another mould, corresponding to enamel layer and the configuration of the tooth. In this an insulating material may be arranged onto the dentin part (54), thus covering the dentin part (54) (at least the part of the final tooth intended to protrude from the artificial jaw). The material of this insulating material onto the dentin part (54) may suitably be selected such that it has similar mechanical properties as a real tooth. In this respect the material may be dental composites, such as Bisphenol A-Glycidyl Methacrylate (BIS-GMA) or it may be acrylic materials.

In an embodiment, the electrically conductive material of the simulated dentin (54) or pulp (55) layer is a carbon, iron or nickel based material. Alternatively, a carbon or iron based material is combined with a nickel coating. The carbon or iron based material is a composition comprising an electrically conducting material and a polymer.

In an embodiment, the electrically conductive material of the simulated dentin (54) or pulp (55) layer is a carbon, iron or nickel based material.

Alternatively, a carbon or iron based material is combined with a nickel coating.

The carbon or iron based material is a composition comprising an electrically conducting material and a polymer.

In an embodiment, the conducting material is chosen from the group consisting of: carbon powder, carbon fiber, stainless steel grades or carbon nanotubes; and the polymer is a polymer chosen from the group comprising: Polyamide (PA 6, PA 66, PA 66/T, PA 46, PA 12); Polyaryletherketone (PAEK); Polybutylentereftalat (PBT); Polycarbonate (PC); Polyethylene (PE (LD, MD, MD, HD)); Polyetethetherketone (PEEK); Polyetherimide (PE1); Polyethersulforte (PES); Polyetylentereftalat (PET); Liquid Crystal Polymer (LCP); Polyoxymethylene (POM); Polypropylene (PP); Polyphenylene amid (PPA); Polyphenylene Sulfide (PPS); Acrylonitrile-Butadiene-Styrene (ABS); PPolySulfone (PSU); PolyStyrene (PS); Thermoplastic Elastomers (Ester and Amide based) (TPE); Thermoplastic urethane (TPU); Thermoplastic olefin (TPO); Epoxy plastic (EPI); Silicone rubber (Q); or Silicone plastic (SI).

The simulated jaw or gum may be made from the above listed materials, with or without the electrically conducting component. In a preferred embodiment, the simulated gum is made from epoxy plastic (EPI). In a preferred embodiment, the simulated artificial bones are made from poly amide (PA).

In a preferred embodiment the composition could be selected a group consisting of:

PRE-ELEC PC 1431, PRE-ELEC PBT 1455, PRE-ELEC PE 1292, PRE-ELEC PE 1294, PRE-ELEC PP 1370, PRE-ELEC PP 1373, PRE-ELEC PP 1375, PRE-ELEC PP 1378, PRE-ELEC PP 1380, PRE-ELEC PP 1382, PRE-ELEC PP 1383, PRE-ELEC PP 1385, PRE-ELEC PP 1387, PRE-ELEC PS 1326, PRE-ELEC 17-031-HI, PRESEAL TPE 5010, PRESEAL TPE 5020, PRESEAL TPE 6070, PRESEAL TIPE 6080, LNP FARADEX AS-1003, LNP FARADEX PS003 E, LNP FARADEX DS00361P, or Loctite 5421™.

Said pain simulator unit is able to generate signals of pseudo pain (62, 63) while tip of the dental syringe (33) needle invades somewhere around the simulated nerve (56).

Said pain simulator unit is able to generate signals of pseudo pain with different intensities (62, 63) according to frequency and location of the generated signals.

Said different pseudo pain intensities (62, 63) in said artificial tooth are generated relative to which of the three simulated layers, enamel (53), dentin (54) or pulp (55) is being drilled.

Signal of pseudo pain with higher intensity (63) temporarily is able to mask signals of pseudo pain with lower intensities (62), for example signal from pulp is able to mask signal from dentin. Once pseudo pain is generated it will last for a period of time depending on which sensor is touched.

This is an advantage, since it provides a more realistic model.

Said different intensities of pseudo pain in said artificial jaw are generated according to presence of needle in different distances to the simulated anatomic landmarks, represented by for example the simulated mandibular nerve.

Said teeth can simulate the generation of pseudo pain signals by means of the same tools used in practicing on a real tooth (such as a dental steel drill (31))

Said jaws can simulate the generation of pseudo pain signals by means of the same tools used in practicing on a jaw (such as a dental syringe (33)). In a basic embodiment the dental syringe (33) is made from an electrically conductive material and may be electrically connected to the data processing unit (58), and the corresponding simulated nerve (56) comprises an electrically conductive multilayered sensor which also is electrically connected to the data processing unit (58).

For practicing it is beneficial to create pseudo numbness as a function of the position of the injection. According to the invention a non exact injection is displayed as delayed pseudo numbness.

Thus, the quality of the injection will affect the pseudo numbness in a fashion very similar to a real jaw. The quality of the injection, as recorded by the multilayered sensor, will affect the timing of pseudo-numbness according to the timing schema.

Now referring to FIG. 18, the multilayered sensor comprises an electrically conducting core surrounded by at least one electrically insulating layer and at least two electrically conducting layers. In an embodiment, the at least two electrically conducting layers (56) comprise electrically conducting silicone. In an embodiment, the at least one electrically insulating layer (47) comprises electrically insulating silicone rubber. In an embodiment, the at least two electrically conducting layers (56) comprise electrically conducting silicone and the at least one electrically insulating layer comprises electrically insulating silicone rubber. In an embodiment, the electrically conducting core comprises electrically conducting silicone.

The electrically conducting core and the at least two electrically conducting layer are connected to data processing unit so that, when the syringe is positioned correctly an electric circuit will be closed and a corresponding signal can be generated by the data processing unit (58) and be sent to the output means. The electrically conducting core corresponds to the ideal position of the syringe and the at least two electrically conducting layer corresponds to a less ideal, but still acceptable, position of the syringe. The at least two electrically conducting layers are positioned on opposite sides of the electrically conducting core. When operational, the signal sent to the data processing unit (58) will thus create an optimal pseudo-numbness for the electrically conducting core and a slightly less optimal pseudo-numbness for the at least two electrically conducting layer. Thus, during operation, when a user is penetrating a first of at least two electrically conducting layer with the syringe (33) and stops there, a less optimal pseudo-numbness is the result (FIG. 18B). If the user penetrates the first of at least two electrically conducting layer and the electrically conducting core and stops there, an optimal pseudo-numbness is the result (FIG. 18C). However, if the user penetrates the first of at least two electrically conducting layer, the electrically conducting core, and then again a second of at least two electrically conducting layers opposite the first of the at least two electrically conducting layers, a less optimal pseudo-numbness is the result (FIG. 18D).

The number of electrically conducting layers may be increased in order to allow more options of pseudo-numbness. Thus, the number of at least two electrically conducting layers and the at least one electrically insulating layers may be 2, 3, 4, 5 or 6, depending on how many options for pseudo-numbness is desired.

In an embodiment according to FIG. 18, a multilayered sensor with two electrically conducting and one electrically insulating layers is shown, plus the electrically conducting core. Thus, the total number of sensor points is three. The quality of the injection will affect the pseudo numbness in a fashion very similar to a real jaw. This is advantageous, since the model is not limited by an exact angle to achieve pseudo-numbness. Instead, the duration of pseudo-numbness is affected by the skill of the user. If wrong angle and or position are used, some level of pseudo-numbness will be achieved, but like in a real situation with a lower level of blocking capacity and a shorter time of duration. This phenomenon is quite similar to real situation

In an embodiment, the dental syringe is not connected to the data processing unit. By positioning the syringe correctly the capacity of the sensor towards the ground is changed, which is measurable.

In yet another embodiment, the dental syringe is not connected to the data processing unit. By positioning the syringe correctly the electromagnetic resonance of the sensor is changed, which is measurable.

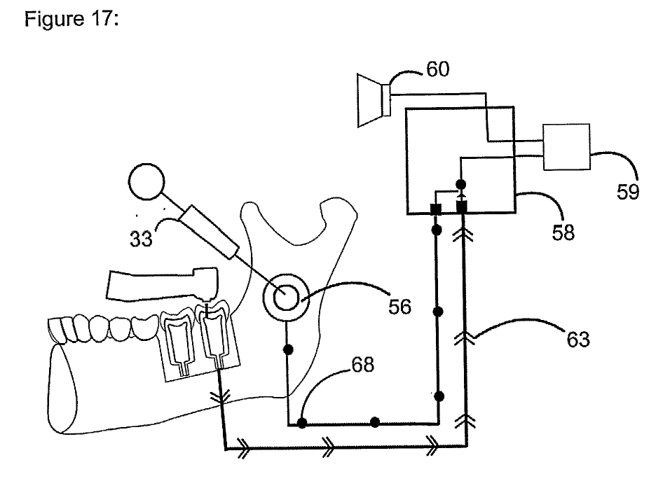

This is advantageous, since it allows the syringe to be used without being attached to the system, which allows for increased flexibility and cost effectiveness (FIG. 17).

Said pain simulator unit is able to simulate painful or painless drilling situations accordingly whether said anesthetic technique is correctly applied or not. Correctly here means injection in correct position.

Said pain block simulator unit is able to simulate anesthesia using a dental syringe (33) in the correct space in said artificial jaw (41, 42). The system does not require real anesthetic agent to be injected in the simulated injection, by entering the needle into the soft tissue of the artificial jaw simulation of numbness can be created.

Said simulated anesthesia has different levels according to the used anesthetic technique and how accurate it can be accomplished by the practitioner on the simulator, accuracy here means only how close the tip of the needle is to the simulated anatomic landmark to provide the desired numbness.

Said jaws are able to simulate the anesthesia procedure by means of the same tools used in practicing on a real mouth (a dental syringe (33)).

Said perception simulator unit is capable of imitating very limited functionality of the central nervous system in terms of receiving signals of pseudo pain with different intensities (62, 63) from sensors; differentiate them and accordingly send the appropriate signal to the audio-visual display unit (60).

Reaction simulator unit is technically an audio-visual display device which simulates reaction to each simulated pain signal by displaying an audible sound (64) and some visible lights, according to frequency and intensity of the simulated pain signal.

Said audio-visual display unit (60) simulates reaction to different pain intensities by displaying different audible sounds with different amplitudes and durations or different visual signal, such as light of different colors or different intensities.

Said model is able to simulate pain while drilling one tooth at a time, which is routinely applied during a dental treatment session.

Said model is able to simulate anesthesia of different areas at the same time which is possible to apply during a dental treatment session.

Generation of pseudo pain signal, transfer, perception and reaction in terms of timing, is quit similar to a real patient's reactions.

Duration of numbness and the starting of numbness after simulated injection are quite similar to the real patient's reaction. The timing schema is divided into two periods. The first period is from time of simulated injection of anesthetic to onset of blocking of the pseudo pain, so called pseudo numbness. The second period is from the onset of pseudo numbness to lapse of pseudo numbness.

In an embodiment, the timing schema is arbitrary within a predetermined range. The duration of the first and second period will be randomly set within a predetermined time range. Duration of each period may vary from experiment to experiment, and may be adjustable by the user.

Touch sensors embedded inside the artificial teeth are not losing their sensitivity due to being drilled meaning that the artificial teeth are reusable as long as related sensors are not totally removed by drilling, i.e. when the connection between the tooth and the system is intact.

The jaws can be produced so that is compatible with the traditional phantom heads to be installed in.

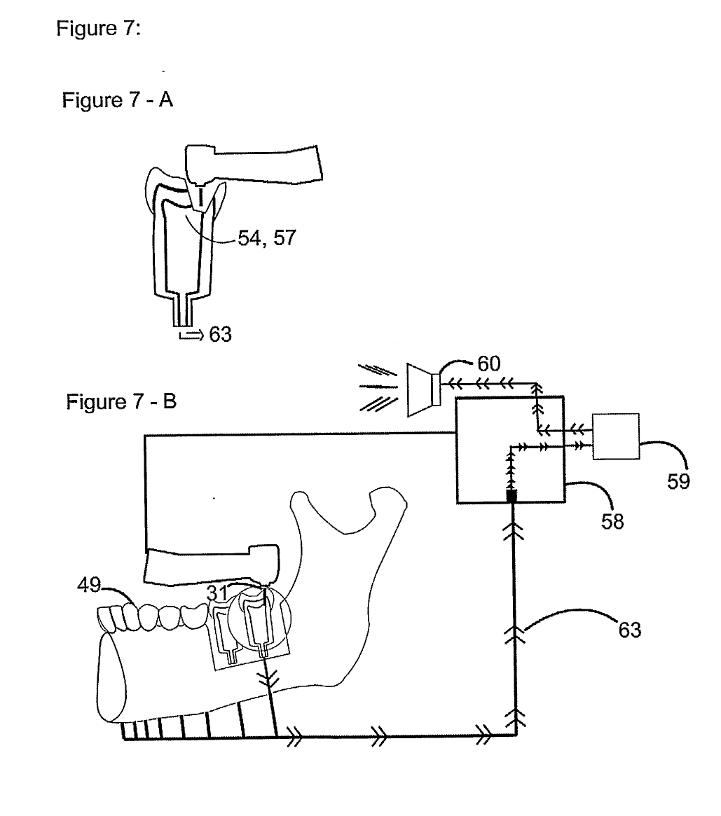

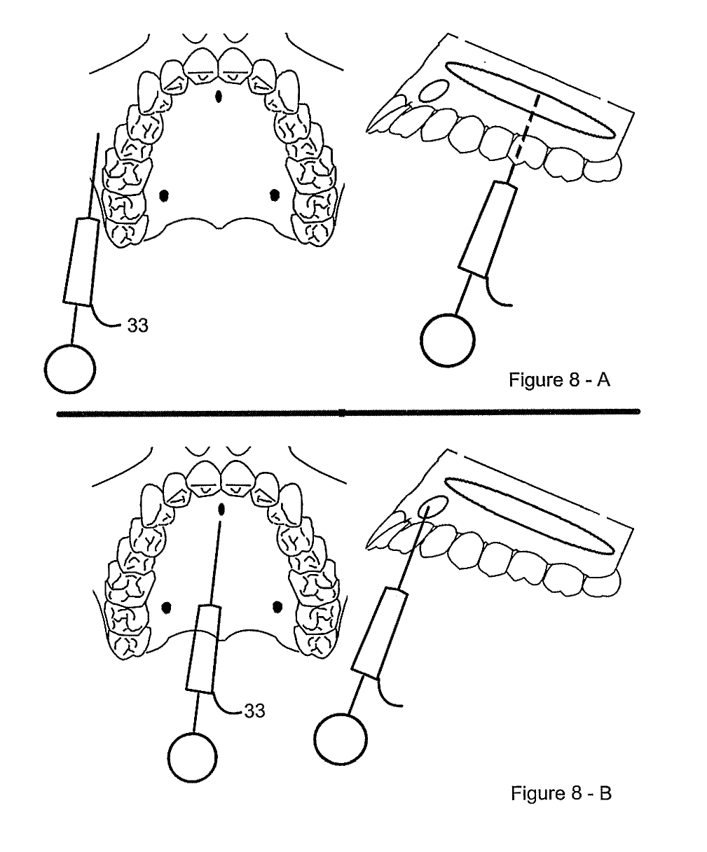

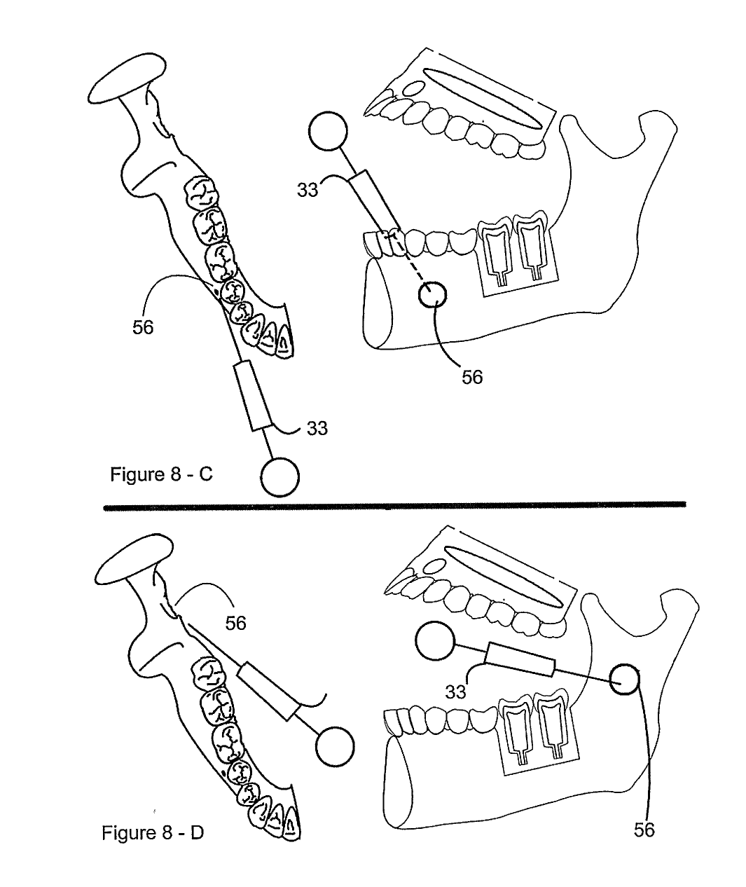

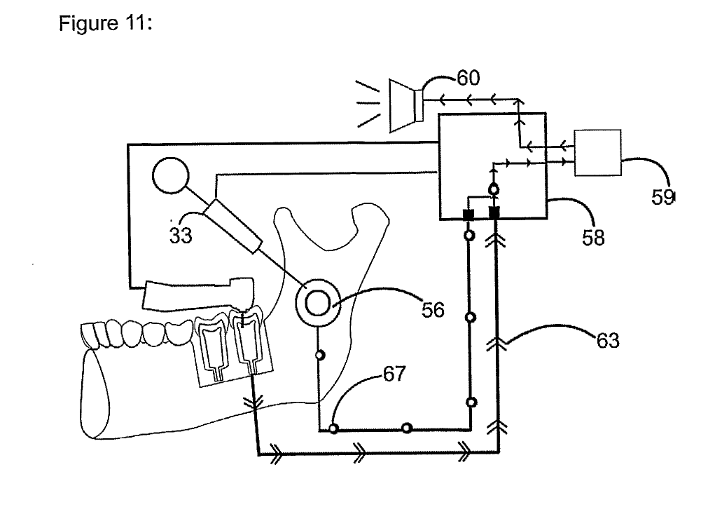

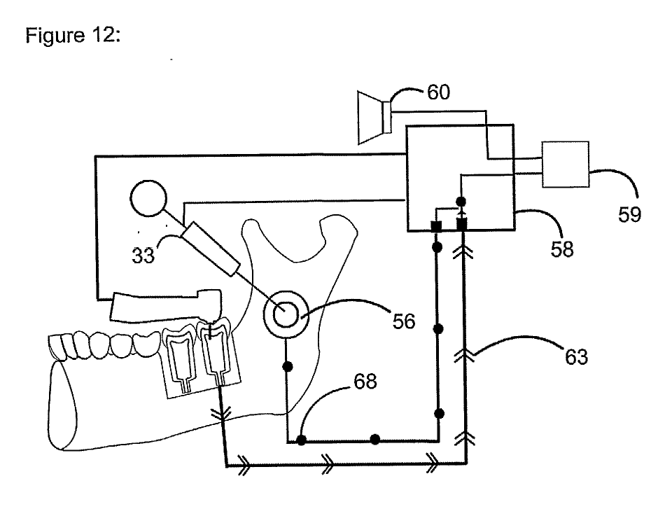

An example of the process of using the system (50) is listed here:
1. After having the system on, the first thing is having an electrically conductive dental handpiece (32) equipped with a steel drill (31) and a dental syringe (33) which may be connected to the system by special connectors.
2. Start using the handpiece to drill the visible part of the artificial tooth on its clinical crown.
3. Referring to FIG. 5, there should be no response (NPPS: No Pseudo Pain Signal) from the model while drilling the simulated enamel layer (53) of the artificial tooth.
4. Referring to FIG. 6 after passing through the simulated enamel layer and exposure of the simulated dentinoenamel junction (61), a cry sound reflecting the response to the simulated pain signal will be heard. If drilling in simulated dentin layer (54) continues the sound will be heard repeatedly, and by continual repetition of drilling, there will be a request sound from the simulator to stop drilling. If drilling is stopped, pseudo pain will exist for a short period of time. This may be indicated by complaining sound.
5. Referring to FIG. 7, if drilling continues through simulated dentin and the simulated pulp layer (55) is exposed a screaming sound will be played from the simulator indicating response for pulp exposure and afterwards a request sound to stop drilling. If drilling is stopped, pseudo pain will exist for a short period of time. This may be indicated by a complaining sound.
6. In the case of inadvertently touching the walls of the cavity even while drill is stopped a screaming sound or cry may be heard indicating touching the sensitive layers in an artificial tooth.
7. Referring to FIGS. 10, 11, 12 in order to have painless situation simulated, injection can be applied. Accurate simulated injection in specific locations is able to block signals from different layers of artificial tooth.
8. Referring to FIG. 8, Depending on which toothiteeth is going to be desensitized a routine anesthetic technique, such as infiltration, nasopalatine nerve block, mental nerve block and inferior alveolar nerve block can be applied. During injection a cry sound may be displayed.
9. After injection, simulated anesthesia starts after 2-5 min and lasts for one or more hours. The pseudo pain may be displayed by sound or light.
10. The depth of anesthesia differs due to accuracy of injection. Accuracy here means the position of the needle's tip in the model and how close it is to the simulated anatomical landmarks as shown in FIG. 18.
11. Different levels of numbness can be simulated in dentin layer and pulp layer: a. Level 0: “Intolerable pain in both pulp and dentin” is simulated by cry and screaming sounds played respectively due to removal of dentin or pulp layer and a request sound to stop drilling. b. Level 1: “Pain in pulp and a little pain in dentin” are simulated by playing a screaming sound in the case of pulp removal in addition to request to stop, and a cry sound in the case of dentin removal but no request to stop when drilling dentin layer, c. Level 2: “Pain in pulp and no pain in dentin” are simulated by playing a screaming sound when the pulp layer is touched, d. Level 3: “No pain” is simulated by no sound out from the audio display device.
12. The simulated numbness will last one or more hours; afterwards some cry sounds will be heard from the audio display device, indicating some pseudo pain in the location of the injection. This period is programmable.

1. A method for practicing dental treatments including the steps of:
a) automatically sensing presence of a first pointed dental tool in a first area of an artificial tooth, said first area corresponding to a simulated dentin layer, and generating a first human perceptible output when said pointed tool is present in said first area;
b) automatically sensing presence of a first pointed dental tool in a second area of an artificial tooth, said second area corresponding to a simulated pulp layer, and generating a second human perceptible output when said pointed tool is present in said second area;
c) automatically sensing presence of a second pointed dental tool at a simulated nerve position in an artificial jaw supporting said artificial tooth, wherein generation of said first or second human perceptible output are blocked during a predetermined time period after said second pointed tool having been present in said simulated nerve position.

2. The method according to claim 1, wherein several different simulated nerve positions are used.

3. The method according to claim 2, wherein the nerve positions is suitable for simulation of the anesthetic techniques chosen from the group consisting of infiltration, nasopalatine nerve block, mental nerve block, inferior alveolar nerve block, greater palatine nerve block, lingual nerve block, buccal nerve block, infra orbital block, or gow-gates technique.

4. The method according to claim 1, wherein the predetermined time period is adjustable and arbitrary.

5. The method according to claim 1, wherein the predetermined time period is divided into a first period from time of simulated injection of anesthetic to onset of blocking of said first or second human perceptible output and a second period from the onset of blocking of said first or second human perceptible output to lapse of blocking of said first or second human perceptible output.

6. The method according to claim 5, wherein the first period is 2 to 5 minutes and the second period is 1 hour to 8 hours.

7. The method according to claim 1, wherein the level of the signal of said first or second human perceptible output is variable.

8. The method according to claim 1, wherein the artificial tooth in claim 11 is used.

9. The method according to claim 1, wherein the device in claim 16 is used.

10. The method according to claim 1, wherein the embedded system in claim 21 is used.

11. An artificial tooth for practicing dental treatments comprising:
a) a first area corresponding to dentin tissue of a human tooth with a first touch sensor provided in the first area; and
b) a second area corresponding to pulp tissue of a human tooth and a second touch sensor provided in the second area,
c) electrical terminals for electrically connecting the tooth to an operative data processing unit, said electrical terminals being conductively connected to said first or second area, wherein said first or second area is a composition comprising an electrically conducting material and a polymer.

12. An artificial tooth according to claim 11, wherein the electrically conducting material is chosen from the group consisting of: carbon powder, carbon fiber, stainless steel grades, carbon nanotubes, and nickel graphite.

13. The artificial tooth according to claim 11, wherein the polymer is chosen from the group consisting of Polyamide (PA 6, PA 66, PA 66/T, PA 46, PA 12); Polyaryletherketone (PAEK); Polybutylentereftalat (PBT); Polycarbonate 35 (PC); Polyethylene (PE (LD, MD, HD)); Polyetheretherketone (PEEK); Polyetherimide (PE1); Polyethersulfone (PES); Polyetylentereftalat (PET); Liquid Crystal Polymer (LCP); Polyoxymethylene (POM); Polypropylene (PP); Polyphenylene amide (PPA); Polyphenylene Sulfide (PPS); Acrylonitrile-Butadiene-Styrene (ABS); PolySulfone (PSU); PolyStyrene (PS); Thermoplastic Elastomers (Ester and Amide based) (TPE); Thermoplastic urethane (TPU); Thermoplastic olefin (TPO); Epoxy plastic (EP1); Silicone rubber (Q) or Silicone plastic (SI).

14. An artificial tooth according to claim 11, wherein the composition is selected from the group consisting of: PRE-ELEC PC1431, PRE-ELEC PBT 1455, PRE-ELEC PE 1292, PRE-ELEC PE 1294, PRE-ELEC PP 1370, PREELEC PP 1373, PRE-ELEC PP 1375, PRE-ELEC PP 1378, PRE-ELEC PP 1380, PRE-ELEC PP 1382, PRE-ELEC PP 1383, PRE-ELEC PP 1385, PRE-ELEC PP 1387, PRE-ELEC PS 1326, PRE-ELEC 17-031-HI, PRESEAL TPE 5010, PRESEAL TPE 5020, PRESEAL TPE 6070, PRESEAL TPE 6080, LNP FARADEX AS-1003, LNP FARADEX PS003E, LNP FARADEX DS00361P, or Loctite 5421™.

15. An artificial tooth according to claim 11, wherein the volume resistivity of the conductive material in the composition is between 0.001 to 10000 Ωcm.

16. A device for practicing dental treatments comprising at least one artificial tooth according to claim 11 and at least a first pointed dental tool and a second pointed dental tool, wherein:
a) said first touch sensor is operatively connected to a data processing unit, wherein said data processing unit is operatively connected to an output device for producing and outputting a first human perceptible signal when said pointed tool is sensed by the first touch sensor;
b) said second touch sensor is operatively connected to the data processing unit, and wherein said data processing unit is operatively connected to said output device for producing and outputting a second human perceptible signal when said pointed tool is sensed by the second touch sensor, said artificial tooth being supported in an artificial jaw, said artificial jaw being provided with
c) a third touch sensor located at a simulated nerve position and operatively connected to the data processing unit, and wherein said data processing unit is operatively connected to said output device for producing and outputting a human perceptible signal when said pointed tool is sensed by the third touch sensor wherein said data processing unit is arranged to disable the first or second human perceptible output signal during a predetermined time period after said second pointed dental tool have been sensed by said third touch sensor.

17. The device in accordance with claim 16, wherein said first, second and third touch sensor comprise electrically conductive layers, operatively connected to the processing unit so that a closed circuit is formed when the first or second pointed dental tool touch the first, second or third touch sensor.

18. The device in accordance with claim 16, wherein said first, second and third touch sensor comprises electrically conductive layers, connected in an open circuit to the processing unit so that a closed circuit is not formed when the first or second pointed dental tool touch the first, second or third touch sensor.

19. The device according to claim 18, wherein said first, second and third touch sensor have different electric capacity.

20. The device according to claim 18, wherein said first, second and third touch sensor have different electromagnetic resonances.

21. An embedded system for practicing dental treatments, said embedded system being configured to perform the method according to claim 1, said embedded system comprising;
a) a first unit, automatically sensing presence of a first pointed dental tool in a first area of an artificial tooth, said first area corresponding to a simulated dentin layer, and generating a first human perceptible output when said pointed tool is present in said first area;
b) a second unit automatically sensing presence of a first pointed dental tool in a second area of an artificial tooth, said second area corresponding to a simulated pulp layer, and generating a second human perceptible output when said pointed tool is present in said second area;
c) a third unit automatically sensing presence of a second pointed dental tool at a simulated nerve position in an artificial jaw supporting said artificial tooth.

22. An embedded system according to claim 21, wherein generation of said first or second human perceptible output are blocked during a predetermined time period after said second pointed tool having been present in said simulated nerve position.

23. An embedded system according to claim 21, wherein the embedded system comprises a programmable processor, data memory, or audiovisual display.
